(19) United States
(12) Patent Application Publication
(10) Pub. No.: US 2012/0306134 A1
(43) Pub. Date: Dec. 6, 2012

(54) FLUID-FILLED TYPE VIBRATION DAMPING DEVICE

(75) Inventors: Eiji TANAKA, Komaki-shi (JP); Toshihiro TANIDA, Komaki-shi (JP)

(73) Assignee: TOKAI RUBBER INDUSTRIES, LTD., Aichi (JP)

(21) Appl. No.: 13/477,549

(22) Filed: May 22, 2012

(30) Foreign Application Priority Data
May 30, 2011 (JP) 2011-119962

(51) Int. Cl. F16F 13/08

(52) U.S. Cl. 267/140.13

(57) ABSTRACT

A fluid-filled type vibration damping device including: a first mounting member positioned at one axial opening side of a tubular portion of a second mounting member; a main rubber elastic body connecting the two mounting members; a plurality of pocket portions that open onto an axial end face of the main rubber elastic body facing a partition member so that a plurality of pressure-receiving chambers are formed by means of the pocket portions being covered with the partition member; an elastic separating wall that is composed by the main rubber elastic body and separates the pressure-receiving chambers from one another; and a dividing recess that opens onto an axial end face of the elastic separating wall facing the partition member so that a dividing fluid chamber is formed by means of the dividing recess being covered with the partition member.

### INCORPORATED BY REFERENCE

The disclosure of Japanese Patent Application No. 2011-119962 filed on May 30, 2011 including the specification, drawings and abstract is incorporated herein by reference in its entirety.

### BACKGROUND OF THE INVENTION

1. Field of the Invention

The present invention relates generally to, for example, a fluid-filled type vibration damping device used preferably for an automotive engine mount or the like.

2. Description of the Related Art

Vibration damping devices designed for installation between components making up a vibration transmission system in order to provide vibration damping linkage and/or vibration damping support between the components are known in the art. The vibration damping devices have a construction in which a first mounting member and a second mounting member are elastically connected by a main rubber elastic body. With the goal of further enhancing vibration damping ability, there have also been proposed vibration damping devices of fluid-filled design adapted to utilize vibration damping effect on the basis of flow action of a non-compressible fluid filling the interior, and such devices are employed as automotive engine mounts or the like. The fluid-filled type vibration damping device further includes: a partition member supported by the second mounting member; a pressure-receiving chamber formed on one side of the partition member and whose wall is partially defined by the main rubber elastic body, while being adapted to give rise to internal pressure fluctuations; and an equilibrium chamber formed on the other side of the partition member and whose wall is partially defined by a flexible film, while permitting change in volume. In addition, an orifice passage is provided for interconnecting the pressure-receiving chamber and the equilibrium chamber. During input of vibration, a non-compressible fluid sealed within the pressure-receiving chamber and the equilibrium chamber will flow through the orifice passage, thereby exhibiting vibration damping effect on the basis of resonance action or other flow action of the fluid.

Meanwhile, in some cases, the fluid-filled type vibration damping device may employ a construction including a plurality of pressure-receiving chambers, with the aim of improving vibration damping ability against vibration input in the axial direction or obtaining effective vibration damping action against vibration input in the axis-perpendicular direction in addition to that in the axial direction, as taught in U.S. Publication No. US 2002/0117788 A1. Specifically, a fluid-filled type vibration damping device shown in FIG. 4 of U.S. Publication No. US 2002/0117788 A1 includes a plurality of pocket portions formed in a main rubber elastic body. By means of openings of the pocket portions being covered with a partition member, a plurality of pressure-receiving chambers separated from one another by an elastic separating wall are provided.

However, since the construction as taught in U.S. Publication No. US 2002/0117788 A1 includes a wide elastic separating wall provided among the pressure-receiving chambers, distributed load of a power unit or load at times of vibration input will act intensively on the elastic separating wall. There is a consequent risk of causing malfunction such as buckling of the elastic separating wall. Furthermore, due to the wide elastic separating wall being compressed in the axial direction, relative displacement of the first and second mounting members will be limited, thereby limiting the amount of fluid flow through the orifice passage. This makes it difficult to efficiently obtain vibration damping effect on the basis of the flow action of the fluid.

### SUMMARY OF THE INVENTION

It is therefore one object of this invention to provide a fluid-filled type vibration damping device of novel construction which is able to ensure durability of the elastic separating wall of the main rubber elastic body which separates the plurality of pressure-receiving chambers, while being capable of improving vibration damping ability owing to increase in the amount of fluid flow.

Specifically, a first mode of the present invention provides a fluid-filled type vibration damping device including: a first mounting member; a second mounting member having a tubular portion so that the first mounting member is positioned at one axial opening side of the tubular portion of the second mounting member; a main rubber elastic body elastically connecting the first mounting member and the second mounting member; a partition member supported by the second mounting member; a plurality of pressure-receiving chambers whose walls are partially defined by the main rubber elastic body and that are formed on one side of the partition member; an equilibrium chamber whose wall is partially defined by a flexible film and that is formed on another side of the partition member, the pressure-receiving chambers and the equilibrium chamber being filled with a non-compressible fluid; a first orifice passage interconnecting the pressure-receiving fluid chambers and the equilibrium fluid chamber; a plurality of pocket portions that are formed in the main rubber elastic body and open onto an axial end face of the main rubber elastic body facing the partition member so as to form the pressure-receiving chambers by means of openings of the pocket portions being covered with the partition member; an elastic separating wall that is composed by the main rubber elastic body and separates the pressure-receiving chambers from one another; a dividing recess that is formed in the elastic separating wall and opens onto an axial end face of the elastic separating wall facing the partition member; and a dividing fluid chamber that is formed by means of an opening of the dividing recess being covered with the partition member and is filled with the non-compressible fluid.

With the fluid-filled type vibration damping device of construction according to the first mode, owing to the presence of the dividing fluid chamber, which is formed by the dividing recess provided to the elastic separating wall, the axial end portion of the elastic separating wall facing the partition member is made thin, thereby readily undergoing elastic deformation upon input of vibration. By so doing, pressure fluctuations within the pressure-receiving chambers will be efficiently obtained, making it possible to advantageously exhibit vibration damping effect based on flow action of the fluid.

Moreover, since the elastic separating wall is divided by the dividing fluid chamber, the second moment of area of the elastic separating wall is reduced. Thus, at times of vibration input in the axis-perpendicular direction, the elastic separating wall readily undergoes elastic deformation (flexural deformation), so that pressure fluctuations within the pressure-receiving chambers will be efficiently obtained. Therefore, it is possible to advantageously attain vibration damping effect based on the flow action of the fluid against vibration input in the axis-perpendicular direction.

Besides, the dividing fluid chamber formed in the elastic separating wall is filled with a non-compressible fluid. Accordingly, when the first mounting member and the second mounting member experience displacement to get closer to each other in the axial direction upon vibration input, the elastic separating wall undergoes elastic deformation so as to bulge towards the pressure-receiving chamber. Consequently, a high discharge efficiency of the fluid from the pressure-receiving chamber can be obtained, thereby increasing the amount of fluid flow through the orifice passage. As a result, vibration damping effect will be exhibited based on the flow action of the fluid. Furthermore, since divided walls of the elastic separating wall that sandwich the dividing fluid chamber undergo flexural deformation so as to bulge towards the respective pressure-receiving chambers, damage to the elastic separating wall can be prevented, thereby improving durability.

Additionally, the openings of the pocket portions, which open onto the axial end face of the main rubber elastic body facing the partition member, are covered with the partition member, thereby forming the pressure-receiving chambers. Therefore, even in the case where stationary load in the axial direction acts across the first mounting member and the second mounting member, the main rubber elastic body will be subjected to dominant compressive deformation, whereby durability is ensured. Also, since the pocket portions open in the axial direction, it is possible to obtain the main rubber elastic body incorporating the pocket portions by means of molds for molding of simple structure.

A second mode of the present invention provides the fluid-filled type vibration damping device according to the first mode, further including a support member provided to the second mounting member so as to span the tubular portion while extending in an axis-perpendicular direction, wherein the support member is bonded to an opening end portion of the elastic separating wall.

According to the second mode, the support member limits deformation of the opening end portion of the elastic separating wall, and retains it in contact against the partition member. Therefore, during input of vibration, the pressure-receiving chambers and the dividing fluid chamber are prevented from being short-circuited through a gap between the elastic separating wall and the partition member, whereby the initial vibration damping ability will be stably retained.

A third mode of the present invention provides the fluid-filled type vibration damping device according to the first mode, further including a relief mechanism that is provided by means of, when an excessive negative pressure acts on the pressure-receiving chambers, an opening end face of the elastic separating wall being spaced away from the partition member and short-circuiting the pressure-receiving chambers and the dividing fluid chamber.

According to the third mode, when large jarring load is input and an excessive negative pressure acts on the pressure-receiving chambers, the pressure-receiving chambers and the dividing fluid chamber become short-circuited through a gap between the elastic separating wall and the partition member. Consequently, fluid flows from the dividing fluid chamber into the pressure-receiving chambers, thereby reducing negative pressure within the pressure-receiving chambers. By so doing, cavitation caused by the negative pressure within the pressure-receiving chambers will be avoided, and the attendant noise can be reduced or eliminated.

A fourth mode of the present invention provides the fluid-filled type vibration damping device according to any one of the first through third modes wherein the pressure-receiving chambers comprise a pair of the pressure-receiving chambers that are situated in opposition to each other in an axis-perpendicular direction.

According to the fourth mode, excellent vibration damping ability can be exhibited especially in the specific axis-perpendicular direction in which the pair of pressure-receiving chambers are opposed to each other. Thus, by having the direction of opposition of the pair of pressure-receiving chambers aligned with the principal vibration input direction in the axis-perpendicular direction, vibration damping effect will be advantageously obtained.

A fifth mode of the present invention provides the fluid-filled type vibration damping device according to the fourth mode wherein the tubular portion of the second mounting member has an oval tube shape, and the pair of the pressure-receiving chambers are situated in opposition to each other in a major axis direction of the tubular portion.

According to the fifth mode, since the tubular portion of the second mounting member has an oval tube shape, the pair of pressure-receiving chambers can be formed with a large capacity, thereby improving vibration damping ability. Moreover, in comparison with the case where the tubular portion has a circular tube shape, it is possible to prevent the tubular portion from increasing in diameter in the minor axis direction, and hence minimize a space for its disposition.

A sixth mode of the present invention provides the fluid-filled type vibration damping device according to any one of the first through fifth modes wherein the first mounting member overlaps the pressure-receiving chambers when viewed in axial direction projection.

According to the sixth mode, at times of vibration input in the axial direction, pressure fluctuations will be efficiently induced within the pressure-receiving chambers, which ensures a large amount of fluid flow through the orifice passage. This makes it possible to advantageously exhibit vibration damping effect based on the flow action of the fluid with respect to vibration in the axial direction, thus improving vibration damping ability.

A seventh mode of the present invention provides the fluid-filled type vibration damping device according to any one of the first through sixth modes wherein the first mounting member overlaps the pressure-receiving chambers when viewed in axis-perpendicular direction projection.

According to the seventh mode, at times of vibration input in the axis-perpendicular direction, pressure fluctuations will be efficiently induced within the pressure-receiving chambers, which ensures a large amount of fluid flow through the orifice passage. This makes it possible to advantageously exhibit vibration damping effect based on the flow action of the fluid with respect to vibration in the axis-perpendicular direction, thus improving vibration damping ability.

An eighth mode of the present invention provides the fluid-filled type vibration damping device according to any one of the first through seventh modes, further including a second orifice passage interconnecting the equilibrium chamber and the dividing fluid chamber.

According to the eighth mode, pressure fluctuations exerted on the dividing fluid chamber during input of vibration will induce fluid flow through the second orifice passage. By so doing, desired vibration damping effect can be obtained based on flow action of the fluid flowing through the second orifice passage.

A ninth mode of the present invention provides the fluid-filled type vibration damping device according to any one of the first through eighth modes, further including a third orifice passage interconnecting the pressure-receiving chambers.

According to the ninth mode, at times of vibration input in the axis-perpendicular direction, on the basis of pressure differential among the plurality of pressure-receiving chambers relative to one another, fluid flow will be produced through the third orifice passage. Therefore, desired vibration damping effect will be exhibited based on the flow action of the fluid flowing through the third orifice passage.

In addition, by setting the tuning frequency of the third orifice passage different from that of the first orifice passage, it is also possible to attain effective vibration damping action with respect to vibration in the axis-perpendicular direction over a wide frequency range.

A tenth mode of the present invention provides the fluid-filled type vibration damping device according to any one of the first through ninth modes, further including a fourth orifice passage interconnecting the pressure-receiving chambers and the dividing fluid chamber.

According to the tenth mode, by providing the fourth orifice passage connecting the pressure-receiving chambers and the dividing fluid chamber, the dividing fluid chamber acts so as to augment the pressure-receiving chambers, thereby increasing the substantial capacity of the pressure-receiving chambers. This will increase the amount of fluid flow through the first orifice passage among the pressure-receiving chambers and the equilibrium chamber, thus enhancing vibration damping effect based on the flow action of the fluid.

According to the present invention, the lower end portion of the elastic separating wall is branched into two forks by the dividing recess, so that the thickness of the elastic separating wall is reduced, as well as reducing the second moment of area of the elastic separating wall. Consequently, the elastic separating wall readily undergoes elastic deformation at times of vibration input. By so doing, during input of vibration, pressure fluctuations within the pressure-receiving chambers will be efficiently induced, thereby advantageously exhibiting vibration damping effect by the orifice passage. Furthermore, the dividing fluid chamber filled with a non-compressible fluid is formed by utilizing the dividing recess. With this arrangement, when the first mounting member and the second mounting member experience displacement to get closer to each other, the branched two forks of the lower end portion of the elastic separating wall undergo deformation so as to bulge towards the respective pressure-receiving chambers. This will enhance durability owing to dispersion of the stress acting thereon.

### BRIEF DESCRIPTION OF THE DRAWINGS

The foregoing and/or other objects, features and advantages of the invention will become more apparent from the following description of a preferred embodiment with reference to the accompanying drawings in which like reference numerals designate like elements and wherein:

FIG. 1 is an elevational view in axial or vertical cross section of a fluid-filled type vibration damping device in the form of an engine mount, which is constructed according to a first embodiment of the present invention;

FIG. 2 is a perspective view of a second mounting member of the engine mount of FIG. 1;

FIG. 3 is a top plane view of the second mounting member of FIG. 2;

FIG. 4 is a bottom plane view of the second mounting member of FIG. 2;

FIG. 5 is an elevational view in axial or vertical cross section of an integrally vulcanization molded component of the engine mount of FIG. 1, taken along line 5-5 of FIG. 6;

FIG. 6 is a cross sectional view taken along line 6-6 of FIG. 5;

FIG. 7 is a bottom plane view of the integrally vulcanization molded component of FIG. 5;

FIG. 8 is an elevational view in axial or vertical cross section of an engine mount according to a second embodiment of the present invention;

FIG. 9 is an elevational view in axial or vertical cross section of an engine mount according to a third embodiment of the present invention;

FIG. 10 is an elevational view in axial or vertical cross section of an engine mount according to a fourth embodiment of the present invention; and

FIG. 11 is an elevational view in axial or vertical cross section of an engine mount according to a fifth embodiment of the present invention.

### DETAILED DESCRIPTION OF PREFERRED EMBODIMENTS

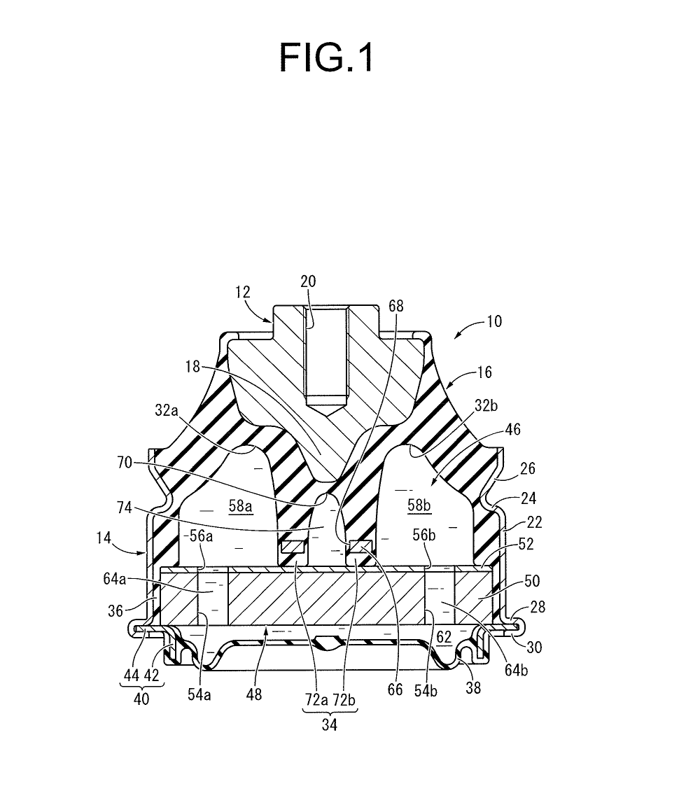

Referring to FIG. 1, there is depicted an automotive engine mount 10 according to a first embodiment of a fluid-filled type vibration damping device constructed in accordance with the present invention. The engine mount 10 has a construction in which a first mounting member 12 and a second mounting member 14 are connected by a main rubber elastic body 16. In the following descriptions, as a general rule, the vertical direction refers to the vertical direction in FIG. 1, which coincides with the vertical direction when installed in a vehicle. In addition, the front-back direction refers to the lateral direction in FIG. 1, which coincides with the vehicle front-back direction when installed in a vehicle.

Described more specifically, the first mounting member 12 is a high rigidity component made of iron, aluminum alloy or the like, and has a generally round block shape overall. A projecting portion 18 having an inverted, generally frustoconical shape is integrally formed with the first mounting member 12 so as to project downward. Additionally, the first mounting member 12 includes a screw hole 20 that extends vertically on the center axis and opens onto its upper face. A screw thread is provided on the inside peripheral face of the screw hole 20.

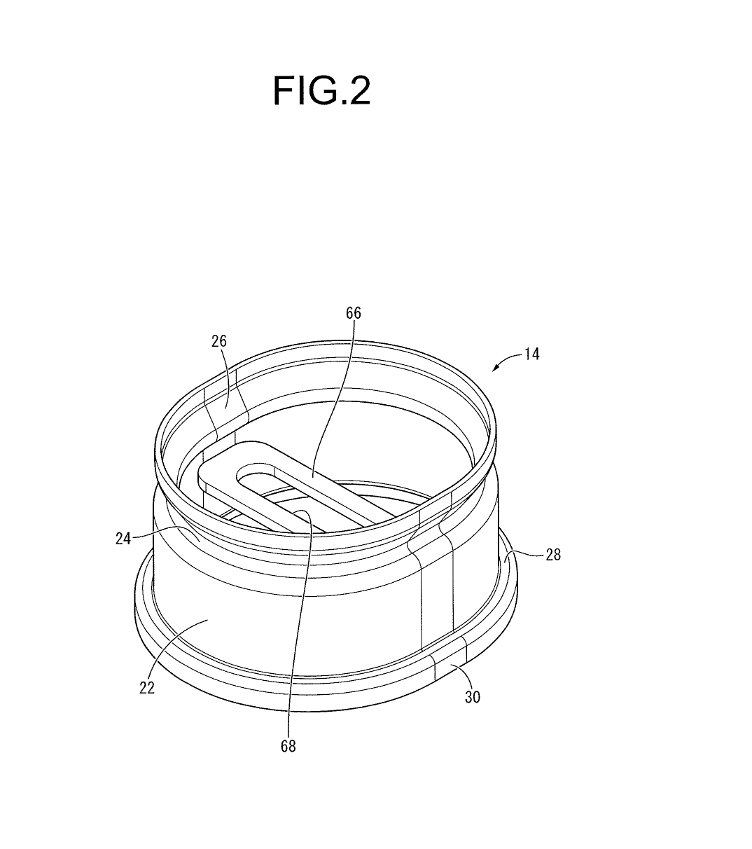

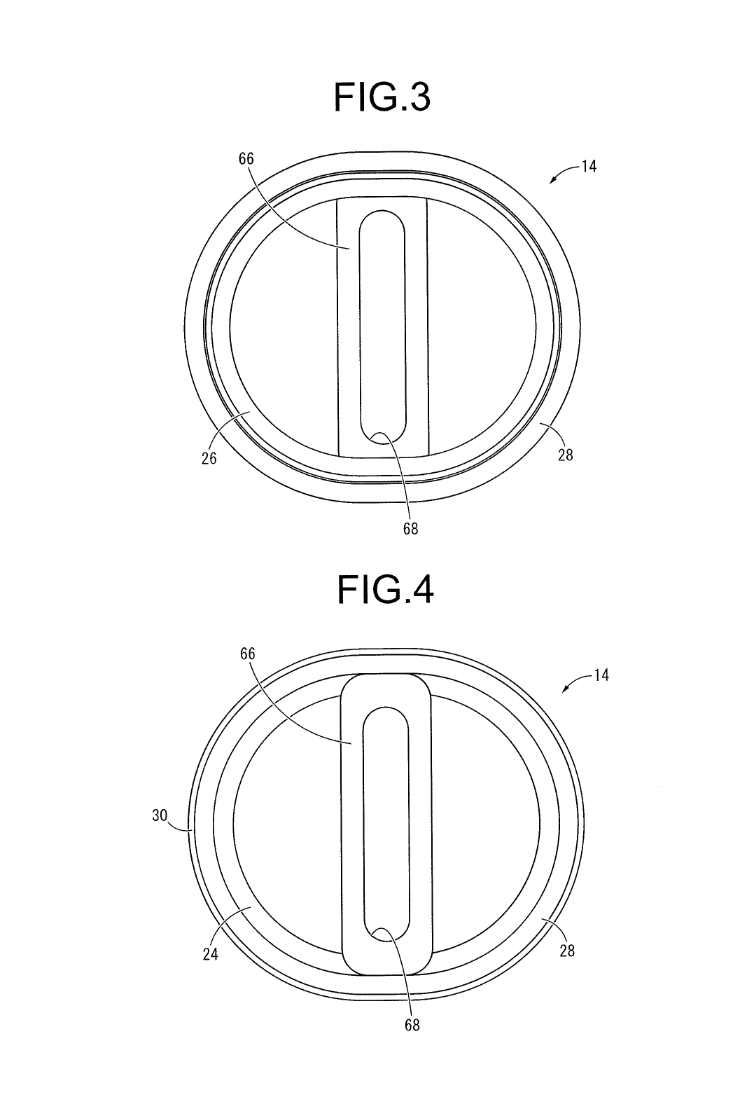

As depicted in FIG. 2 through FIG. 4, the second mounting member 14 has a thin-walled, large-diameter, generally oval tube shape, and is a high rigidity component made of material similar to the first mounting member 12. The second mounting member 14 includes at its axially medial section a tubular portion 22 having an oval tube shape. At the upper end portion of the tubular portion 22 provided is a shoulder portion 24 that curves in an inner flanged shape, and a tapered portion 26 projects from the inner peripheral edge of the shoulder portion 24 and progressively flares out towards the top. Meanwhile, at the lower end portion of the second mounting member 14, a flange portion 28 is integrally formed, and a tubular caulking piece 30 projects downward from the outer peripheral edge of the flange portion 28.

The first mounting member 12 is positioned at one axial opening side (upper side) of the tubular portion 22 of the second mounting member 14 so as to be coaxial with the second mounting member 14. Moreover, the projecting portion 18 of the first mounting member 12 is inserted downward from the upper opening of the second mounting member 14, so that the projecting portion 18 and the upper end portion of the second mounting member 14 overlap each other when viewed in axis-perpendicular direction projection.

The first mounting member 12 and the second mounting member 14 arranged in this way are elastically connected by the main rubber elastic body 16. The main rubber elastic body 16 has a thick-walled, large-diameter, generally frustoconical shape that progressively becomes smaller in its diameter toward one axial side (upper side in the axial direction). The first mounting member 12 is bonded by vulcanization to the small-diameter side end of the main rubber elastic body 16, while the inner circumferential face of the second mounting member 14 is superposed against and bonded by vulcanization to the outer circumferential face of the large-diameter side end of the main rubber elastic body 16. In the present embodiment, the main rubber elastic body 16 takes the form of an integrally vulcanization molded component incorporating the first mounting member 12 and the second mounting member 14.

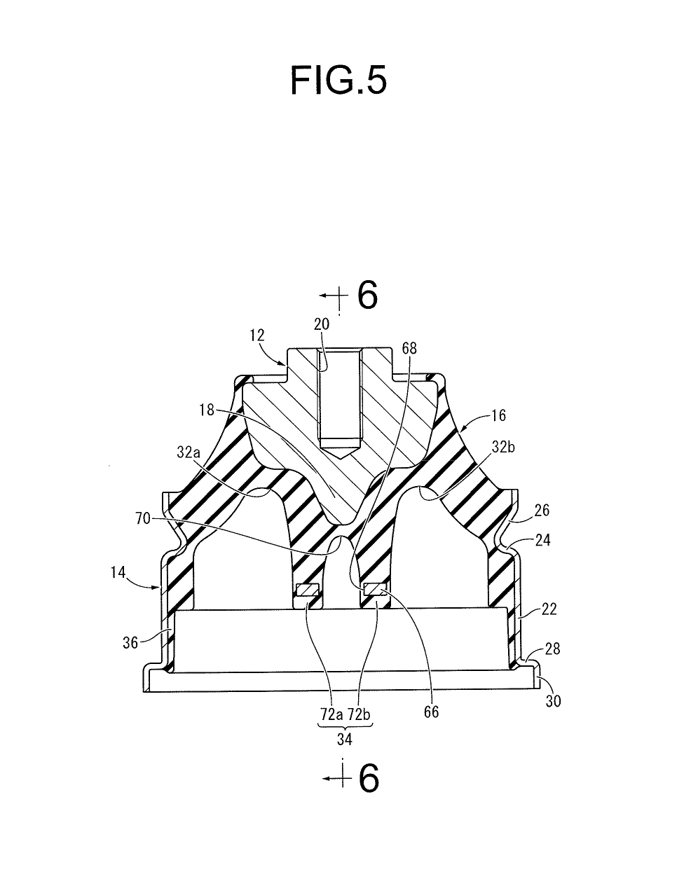

Additionally, the main rubber elastic body 16 includes a pair of pocket portions 32a, 32b. As depicted in FIG. 5 through FIG. 7, the pocket portion 32a/32b is a recess that opens onto the lower face of the main rubber elastic body 16 (facing the partition member 48 described later) and has a generally semicircular shape viewed in the axial direction. The bottom surface of the pocket portion 32a/32b has generally tapered contours such that the depth is greater at its inner peripheral side than at its outer peripheral side. Besides, the deepest portion of the pocket portion 32a/32b overlaps the first mounting member 12 when viewed in axial direction projection. Furthermore, in the present embodiment, the pair of pocket portions 32a, 32b are situated in opposition to each other along an axis lying in the axis-perpendicular direction, which coincides with the major axis direction of the tubular portion 22 of oval tube shape. Also, the pair of pocket portions 32a, 32b are generally identical with each other in shape.

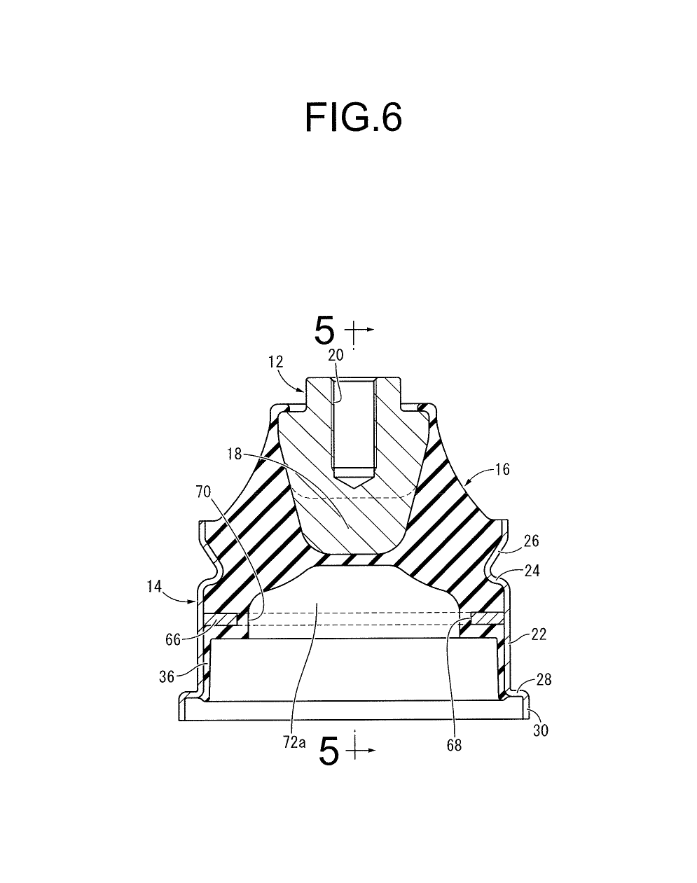

By providing the pair of pocket portions 32a, 32b, an elastic separating wall 34 is formed diametrically between the pair of pocket portions 32a, 32b. The elastic separating wall 34 is composed by a part of the main rubber elastic body 16, and has a generally plate shape that extends in the diametrical direction which is perpendicular to the direction of opposition of the pair of pocket portions 32a, 32b. The upper portion of the elastic separating wall 34 becomes progressively thinner towards its lower side, while its lower portion has a generally unchanging thickness. As depicted in FIG. 5, the elastic separating wall 34 is disposed in the front-back direction center of the first mounting member 12, and the lateral center portion of the elastic separating wall 34 overlaps the first mounting member 12 when viewed in axial direction projection (see FIG. 6).

A seal rubber layer 36 extends from the outer peripheral edge of the main rubber elastic body 16. The seal rubber layer 36 is a rubber elastic body of thin-walled, large-diameter, generally oval tube shape which is integrally formed with the main rubber elastic body 16, and extends downward. The seal rubber layer 36 is superposed against the inner circumferential face of the second mounting member 14 and covers the inner circumferential face of the tubular portion 22.

A flexible film 38 is attached to the lower end portion of the second mounting member 14. The flexible film 38 is a thin-walled rubber film of generally circular disk shape, and has an ample slack in the vertical direction. In addition, a holding member 40 is anchored to the outer peripheral edge of the flexible film 38. The holding member 40 is an annular body which is integrally equipped with a tubular anchor portion 42 and a caulked portion 44 projecting peripherally outward from the upper end of the anchor portion 42. The caulked portion 44 of the holding member 40 is detained by caulking with the caulking piece 30 of the second mounting member 14, whereby the flexible film 38 is attached to the second mounting member 14 so as to cover its lower opening.

With the flexible film 38 attached to the second mounting member 14 in this way, the upper opening of the second mounting member 14 is closed off by the main rubber elastic body 16, while the lower opening of the second mounting member 14 is closed off by the flexible film 38. By so doing, there is formed a fluid-filled zone 46 between axially opposed faces of the main rubber elastic body 16 and the flexible film 38, which is sealed off from the outside. The fluid-filled zone 46 is filled with a non-compressible fluid. While no particular limitation is imposed as to the non-compressible fluid filling the fluid-filled zone 46, preferred examples are water, alkylene glycols, polyalkylene glycols, silicone oil, and mixtures of these. In terms of efficiently achieving vibration damping action based on flow action of the fluid described later, a low-viscosity fluid having viscosity of 0.1 Pa·s or lower is especially preferred.

Besides, a partition member 48 supported by the second mounting member 14 is disposed within the fluid-filled zone 46. The partition member 48 is of thick-walled, large-diameter, generally oval circular disk shape, and in the present embodiment, comprises a partition member body 50 and a lid member 52.

The partition member body 50 is a high rigidity component of thick-walled, large-diameter, generally oval circular disk shape, and is perforated by communication holes 54a, 54b in the vertical direction. The communication holes 54a, 54b are both formed in the front-back direction medial section of the partition member body 50, and situated on opposite sides of the center axis in the front-back direction.

The lid member 52 is a high rigidity component of thin-walled, large-diameter, generally oval circular disk shape, and is generally identical in shape with the partition member body 50 viewed in the axial direction. In addition, the lid member 52 is perforated in the vertical direction by a pair of through holes 56a, 56b at locations corresponding to the communication holes 54a, 54b of the partition member body 50.

The partition member body 50 and the lid member 52 are superposed against each other in the vertical direction so as to constitute the partition member 48. The partition member 48 is supported by the second mounting member 14 and disposed within the fluid-filled zone 46. Specifically, the partition member 48 is inserted into the tubular portion 22 of the second mounting member 14 from below and fitted to the inner peripheral side of the seal rubber layer 36. With the holding member 40 detained by caulking against the second mounting member 14, the partition member 48 is clasped axially between opposed faces of the lower face of the main rubber elastic body 16 and the holding member 40.

Moreover, with the partition member 48 disposed within the fluid-filled zone 46 so as to spread in the axis-perpendicular direction, the lower faces of the main rubber elastic body 16 and the elastic separating wall 34 are positioned in abutment with the upper face of the partition member 48, so that the openings of the pocket portions 32a, 32b are closed off by the partition member 48. With this arrangement, on the upper side of the partition member 48, a pair of pressure-receiving chambers 58a, 58b are formed by utilizing the pocket portions 32a, 32b, whose walls are partially defined by the main rubber elastic body 16 and which is subjected to internal pressure fluctuations during input of vibration.

As will be apparent from the arrangement of the pair of pocket portions 32a, 32b, the pair of pressure-receiving chambers 58a, 58b are situated in opposition to each other along an axis lying in the axis-perpendicular direction, which coincides with the major axis direction of the second mounting member 14. Furthermore, the inside peripheral portions of the pressure-receiving chambers 58a, 58b overlap the first mounting member 12 when viewed in axial direction projection, while the upper end portions of the pressure-receiving chambers 58a, 58b overlap the projecting portion 18 of the first mounting member 12 when viewed in axis-perpendicular direction projection.

On the other hand, on the lower side of the partition member 48, there is formed an equilibrium chamber 62 whose wall is partially defined by the flexible film 38 and that readily permits changes in volume. That is, the fluid-filled zone 46 is bifurcated into upper and lower parts by the partition member 48, so that the upper part defines the pressure-receiving chambers 58a, 58b and the lower part defines the equilibrium chamber 62. The pressure-receiving chambers 58a, 58b and the equilibrium chamber 62 are each filled with the non-compressible fluid filling the fluid-filled zone 46.

Additionally, the communication holes 54a, 54b of the partition member body 50 and the respective through holes 56a, 56b of the lid member 52 are vertically superposed and connected to each other. Here, the through holes 56a, 56b open to the respective pressure-receiving chambers 58a, 58b, while the communication holes 54a, 54b both open to the equilibrium chamber 62. This arrangement provides first orifice passages 64a, 64b interconnecting the pressure-receiving chambers 58a, 58b and the equilibrium chamber 62. By adjusting the ratio (A/L) of passage cross sectional area (A) to passage length (L) with consideration to the wall spring rigidity of the pressure-receiving chambers 58a, 58b and the equilibrium chamber 62, the first orifice passages 64a, 64b are tuned to a low frequency of around 10 Hz corresponding to engine shake. In the present embodiment, the first orifice passage 64a, which interconnects the pressure-receiving chamber 58a and the equilibrium chamber 62, and the first orifice passage 64b, which interconnects the pressure-receiving chamber 58b and the equilibrium chamber 62, are tuned to the same frequency. However, the plurality of first orifice passages 64a, 64b may be tuned to mutually different frequencies. A broader vibration damping ability (exhibition of vibration damping effect over a wider frequency range) can be attained thereby.

A support member 66 provided to the second mounting member 14 is anchored to the elastic separating wall 34 of the main rubber elastic body 16, and the lower face of the elastic separating wall 34 is held in contact against the upper face of the partition member 48. As depicted in FIG. 2 through FIG. 4, the support member 66 is a component of plate shape and extends with its lengthwise direction aligned with the minor axis direction (lateral direction) of the tubular portion 22. The center section of the support member 66 is perforated by a window portion 68 that has a generally elliptical shape viewed in the axial direction. The support member 66 is arranged at the axially medial section of the tubular portion 22 with its lengthwise opposite ends secured to the tubular portion 22 by welding or the like so as to span the tubular portion 22 while extending in the diametrical direction. Moreover, as depicted in FIG. 5 through FIG. 7, the support member 66 is embedded and bonded by vulcanization in the lower end portion (the opening end portion) of the elastic separating wall 34 of the main rubber elastic body 16. By so doing, the lower end portion of the elastic separating wall 34 is positioned by the support member 66 and is pressed against the upper face of the partition member 48.

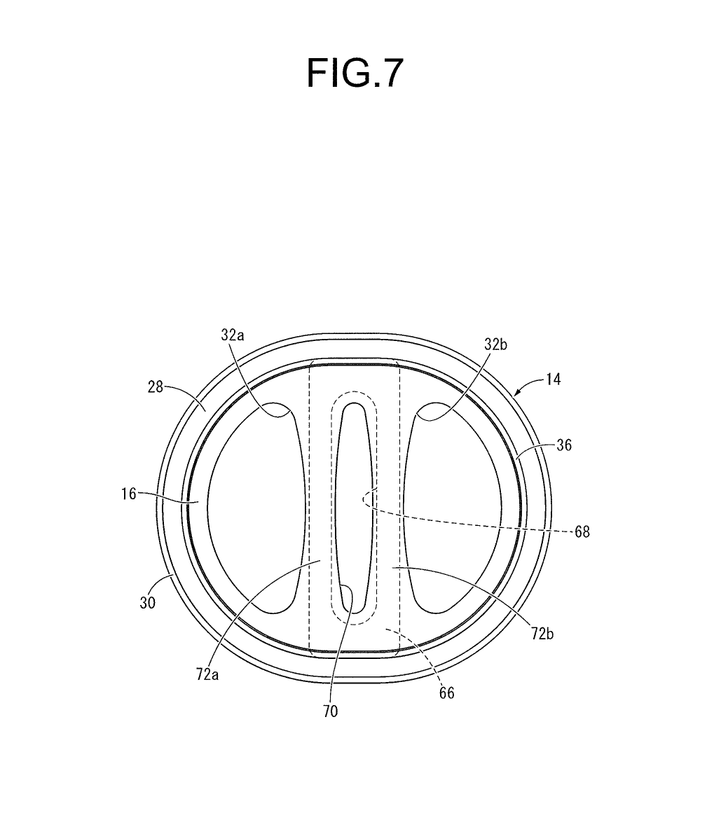

Furthermore, the elastic separating wall 34 that separates the pressure-receiving chamber 58a and the pressure-receiving chamber 58b includes a dividing recess 70 formed therein. The dividing recess 70 is a recess of generally oval shape whose major axis is aligned with the minor axis direction (lateral direction) of the main rubber elastic body 16 viewed in the axial direction. The upper portion (base portion) of the dividing recess 70 progressively flares out downward towards its opening side, while its lower portion (opening) has a generally unchanging cross-sectional shape. The dividing recess 70 is formed within the window portion 68 of the support member 66 and opens onto the lower face of the elastic separating wall 34 (facing the partition member 48). Note that the maximum depth dimension of the dividing recess 70 is made smaller than that of the pair of pocket portions 32a, 32b, so that the dividing recess 70 is formed below the projecting portion 18 of the first mounting member 12 which overlaps the pocket portions 32a, 32b when viewed in axis-perpendicular direction projection. In addition, when measured in the lateral direction (vertical direction in FIG. 7), the maximum dimension of the dividing recess 70 is approximately equal to that of the pocket portions 32a, 32b. Meanwhile, when measured in the front-back direction, the maximum dimension of the dividing recess 70 is smaller than that of the pocket portions 32a, 32b. Thus, the dividing recess 70 has a smaller capacity than the pocket portions 32a, 32b.

Moreover, the dividing recess 70 branches the lower portion of the elastic separating wall 34 into two forks in the width direction (front-back direction), thereby defining the branched lower portion of the elastic separating wall 34 as a pair of divided walls 72a, 72b. The divided walls 72a, 72b are generally identical with each other in shape, and their upper portion has a tapered plate shape that becomes progressively thinner towards their lower side, while their lower portion has a flat-plate shape of generally unchanging thickness. Additionally, the divided walls 72a, 72b are made thinnest in their lateral center portion, and made progressively thicker towards the outer side in the lateral direction. The lower portions of the divided walls 72a, 72b are respectively bonded by vulcanization to the corresponding front/back portions of the support member 66 with the window portion 68 interposed in between, and displacement of the divided walls 72a, 72b is limited by the support member 66.

Then, each lower face of the pair of divided walls 72a, 72b is superposed against the upper face of the partition member 48 so that the opening of the dividing recess 70 is covered with the partition member 48. Accordingly, there is formed a dividing fluid chamber 74 filled with the non-compressible fluid. The dividing fluid chamber 74 is provided between the diametrically opposed pressure-receiving chamber 58a and the pressure-receiving chamber 58b, and is separated from the pressure-receiving chambers 58a, 58b by the divided walls 72a, 72b, while being separated and sealed off from the equilibrium chamber 62 by the partition member 48. Note that the dividing fluid chamber 74 is arranged below the projecting portion 18 of the first mounting member 12 so as to overlap each other when viewed in axial direction projection.

The engine mount 10 of the above construction is adapted to be mounted onto a vehicle by the first mounting member 12 being attached to a power unit (not shown) and the second mounting member 14 being attached to a vehicle body (not shown). With this mounted state onto the vehicle, the distributed load of the power unit is input across the first mounting member 12 and the second mounting member 14, whereby the first mounting member 12 is displaced to get closer to the second mounting member 14 in the axial direction. Since the main rubber elastic body 16 of the engine mount 10 has a generally frustoconical shape, the distributed load of the power unit acts on the main rubber elastic body 16 mainly in the compression direction, thereby ensuring durability. Whereas the pair of divided walls 72a, 72b are also compressed, owing to the presence of the dividing fluid chamber 74 substantially sealed off between the pair of divided walls 72a, 72b, the divided wall 72a undergoes elastic deformation so as to bulge towards the pressure-receiving chamber 58a, while the divided wall 72b undergoes elastic deformation so as to bulge towards the pressure-receiving chamber 58b.

With the mounted state onto the vehicle, at times of input of low-frequency, large-amplitude vibration in the axial direction which corresponds to engine shake, fluid flow will be produced among the pressure-receiving chambers 58a, 58b and the equilibrium chamber 62 through the first orifice passages 64a, 64b on the basis of pressure fluctuations arising in the pressure-receiving chambers 58a, 58b relative to the equilibrium chamber 62. By so doing, based on resonance action or other flow action of the fluid, desired vibration damping effect (high attenuating or damping action) will be exhibited.

Similarly, at times of input of low-frequency, large-amplitude vibration in the axis-perpendicular direction, fluid flow will also be produced among the pressure-receiving chambers 58a, 58b and the equilibrium chamber 62 through the first orifice passages 64a, 64b, thereby obtaining vibration damping effect based on flow action of the fluid. In particular, with the engine mount 10, the pair of pressure-receiving chambers 58a, 58b are disposed so as to be opposed to each other in the principal vibration input direction of the axis-perpendicular direction. Thus, excellent vibration damping effect by the pair of first orifice passages 64a, 64b can be achieved along an axis lying in the axis-perpendicular direction for which vibration attenuating action is required.

With respect to the engine mount 10, the dividing fluid chamber 74 is formed in the elastic separating wall 34 of the main rubber elastic body 16, so that the elastic separating wall 34 branches into the pair of divided walls 72a, 72b. Thus, vibration damping effect by the first orifice passages 64a, 64b will be efficiently obtained. Specifically, owing to the formation of the dividing fluid chamber 74, the substantial thickness dimension of the elastic separating wall 34 is reduced, as well as reducing the second moment of area of the elastic separating wall 34. Consequently, the elastic separating wall 34 readily undergoes elastic deformation, whereby the first mounting member 12 easily displaces relative to the second mounting member 14. This will effectively induce pressure fluctuations within the pressure-receiving chambers 58a, 58b, producing sufficient amount of fluid flow through the first orifice passages 64a, 64b. As a result, desired vibration damping effect can be advantageously exhibited.

Additionally, since the sealed-off dividing fluid chamber 74 is filled with a non-compressible fluid, when the first mounting member 12 and the second mounting member 14 displace to get relatively closer to each other, the divided wall 72a undergoes flexural deformation so as to bulge towards the pressure-receiving chamber 58a, while the divided wall 72b undergoes flexural deformation so as to bulge towards the pressure-receiving chamber 58b. Accordingly, pressure fluctuations will be efficiently exerted on the pressure-receiving chambers 58a, 58b, thereby advantageously achieving vibration damping effect by the first orifice passages 64a, 64b.

Moreover, as described above, the mode of deformation of the divided wall 72a and the divided wall 72b is specified so as to deform in the direction of bulging towards the respective pressure-receiving chambers 58a, 58b. Thus, unstable deformation such as buckling will be prevented, thereby avoiding localized stress concentration during deformation. Besides, since the divided wall 72a and the divided wall 72b deform independently of each other, stress due to deformation will act dispersedly on the divided wall 72a and the divided wall 72b, thereby improving durability of the elastic separating wall 34.

Furthermore, the support member 66 is anchored to the lower end portion of the divided walls 72a, 72b, and displacement of the divided walls 72a, 72b relative to the partition member 48 is limited. Therefore, the pressure-receiving chambers 58a, 58b and the dividing fluid chamber 74 are kept independent of one another without being short-circuited, making it possible to stabilize vibration damping ability.

In addition, the pressure-receiving chambers 58a, 58b overlap the first mounting member 12 when viewed in axial direction projection. Accordingly, during input of vibration in the axial direction across the first mounting member 12 and the second mounting member 14, internal pressure fluctuations will effectively be induced within the pressure-receiving chambers 58a, 58b. Thus, it is possible to obtain desired vibration damping effect with respect to the vibration input in the axial direction.

Besides, the pressure-receiving chambers 58a, 58b overlap the projecting portion 18 of the first mounting member 12 when viewed in axis-perpendicular direction projection. Thus, during input of vibration in the axis-perpendicular direction across the first mounting member 12 and the second mounting member 14, internal pressure fluctuations will effectively be induced within the pressure-receiving chambers 58a, 58b. Therefore, it is possible to obtain desired vibration damping effect with respect to the vibration input in the axis-perpendicular direction.

Also, the tubular portion 22 of the second mounting member 14 has an oval tube shape, and the pair of pressure-receiving chambers 58a, 58b are situated in opposition to each other along the major axis direction of the tubular portion 22. A large capacity of the pressure-receiving chambers 58a, 58b can be obtained thereby. Moreover, in the minor axis direction which is perpendicular to the direction of opposition of the pressure-receiving chambers 58a, 58b, the outside diameter dimension of the tubular portion 22 is made small. Thus, there is no need to ensure a space for disposition any more than necessary, while efficiently obtaining a sufficient capacity of the pressure-receiving chambers 58a, 58b.

Additionally, all of the pair of pocket portions 32a, 32b and the dividing recess 70 open onto the lower face of the main rubber elastic body 16 in the axial direction. This makes it possible to mold the main rubber elastic body 16 by vulcanization using molds for molding which are put together vertically. In this way, according to the construction of the present embodiment, it is possible to obtain the engine mount 10 equipped with a plurality of fluid chambers without needing any complicated mold structure.

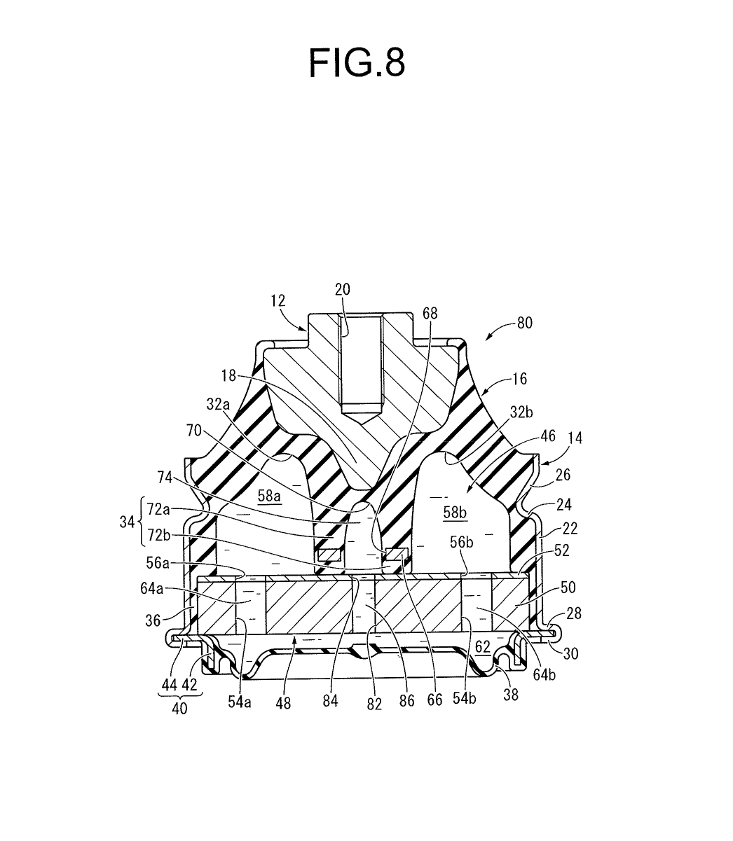

Next, referring to FIG. 8, there is depicted an automotive engine mount 80 according to a second embodiment of a fluid-filled type vibration damping device constructed in accordance with the present invention. In the engine mount 80, the center section of the partition member body 50 is perforated by a center communication hole 82 in the axial direction, and the center section of the lid member 52 is perforated by a center through hole 84 in the axial direction. In the following description, components and parts that are substantially identical with those in the first embodiment will be assigned like symbols and not described in any detail.

By means of the partition member body 50 and the lid member 52 being superposed against each other in the vertical direction, the center communication hole 82 and the center through hole 84 are interconnected. Moreover, the center communication hole 82 opens to the equilibrium chamber 62 while the center through hole 84 opens to the dividing fluid chamber 74, thereby providing a second orifice passage 86 interconnecting the equilibrium chamber 62 and the dividing fluid chamber 74 through cooperation of the center communication hole 82 and the center through hole 84. Note that the second orifice passage 86 may be tuned to the same frequency as that of the first orifice passages 64a, 64b, or may alternatively be tuned to a different frequency therefrom.

With the engine mount 80 of this construction, at times of vibration input in the axial direction, pressure fluctuations will be exerted on the dividing fluid chamber 74 relatively to the equilibrium chamber 62, thereby producing fluid flow between the dividing fluid chamber 74 and the equilibrium chamber 62 through the second orifice passage 86. Consequently, vibration damping effect will be exhibited on the basis of the flow action of the fluid, thereby improving vibration damping ability.

It should be appreciated that when the second orifice passage 86 is tuned to the same frequency as that of the first orifice passages 64a, 64b, enhanced vibration damping ability can be achieved with respect to the vibration of the frequency to which the first and second orifice passages 64a, 64b and 86 are tuned.

On the other hand, when the second orifice passage 86 is tuned to a different frequency from that of the first orifice passages 64a, 64b, effective vibration damping action will be exhibited with respect to vibration input over a wider frequency range.

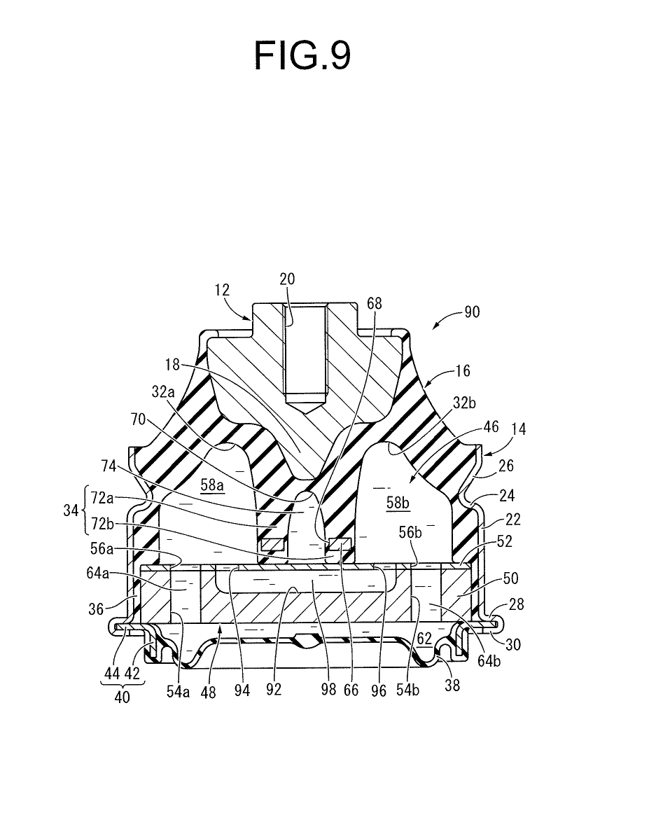

Referring next to FIG. 9, there is depicted an automotive engine mount 90 according to a third embodiment of a fluid-filled type vibration damping device constructed in accordance with the present invention. In the engine mount 90, the partition member body 50 includes a center recessed groove 92 that opens onto the upper face thereof and extends a prescribed length in the diametrical direction, while the lid member 52 includes a first through hole 94 and a second through hole 96 that perforate the lid member 52 in the axial direction and are situated so as to be spaced away from each other in the diametrical direction.

By means of the partition member body 50 and the lid member 52 being superposed against each other in the vertical direction, the opening of the center recessed groove 92 is covered by the lid member 52 so as to provide a tunnel-like passage. Moreover, one end of the tunnel-like passage communicates with the pressure-receiving chamber 58a via the first through hole 94, while the other end of the tunnel-like passage communicates with the pressure-receiving chamber 58b via the second through hole 96, thereby providing a third orifice passage 98 interconnecting the pressure-receiving chamber 58a and the pressure-receiving chamber 58b. Note that the third orifice passage 98 may be tuned to the same frequency as that of the first orifice passages 64a, 64b, but will preferably be tuned depending on the frequency of vibration input in the axis-perpendicular direction.

With the engine mount 90 of this construction, at times of vibration input in the axis-perpendicular direction, on the basis of pressure fluctuations within the pair of pressure-receiving chambers 58a, 58b relative to each other, fluid flow will be produced through the third orifice passage 98. Therefore, vibration damping effect based on the flow action of the fluid will be exhibited not only by the first orifice passages 64a, 64b but also by the third orifice passage 98, thereby realizing more excellent vibration damping ability.

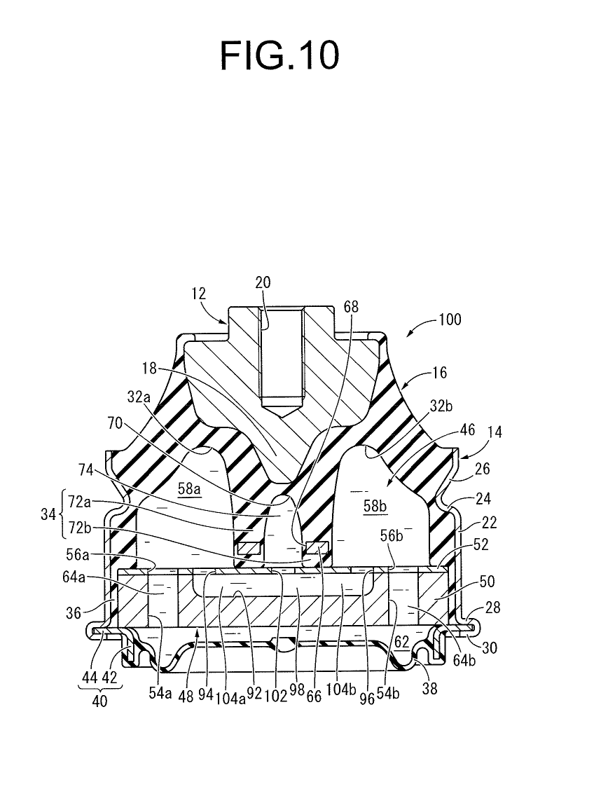

Referring next to FIG. 10, there is depicted an automotive engine mount 100 according to a fourth embodiment of a fluid-filled type vibration damping device constructed in accordance with the present invention. In comparison with the engine mount 90 illustrated in the third embodiment, the lid member 52 of the engine mount 100 further includes a center through hole 102 at its center.

The center through hole 102 is superposed against the lengthwise center section of the center recessed groove 92, so that the center recessed groove 92 communicates with the dividing fluid chamber 74 via the center through hole 102. Accordingly, there are formed a pair of fourth orifice passages 104a, 104b interconnecting the pressure-receiving chambers 58a, 58b and the dividing fluid chamber 74. Whereas the fourth orifice passages 104a, 104b are formed by utilizing the passage of the third orifice passage 98 in common, the fourth orifice passages 104a, 104b may alternatively be formed separately from the third orifice passage 98. Also, the pair of fourth orifice passages 104a, 104b may be formed independently of each other.

With the engine mount 100 of this construction, at times of vibration input in the axial direction, the dividing fluid chamber 74 functions as an auxiliary fluid chamber that augments the capacity of the pressure-receiving chambers 58a, 58b. This will increase the substantial capacity of the pressure-receiving chambers 58a, 58b, thereby obtaining a large amount of fluid flow through the first orifice passages 64a, 64b. Therefore, it is possible to advantageously achieve vibration damping effect based on the flow action of the fluid.

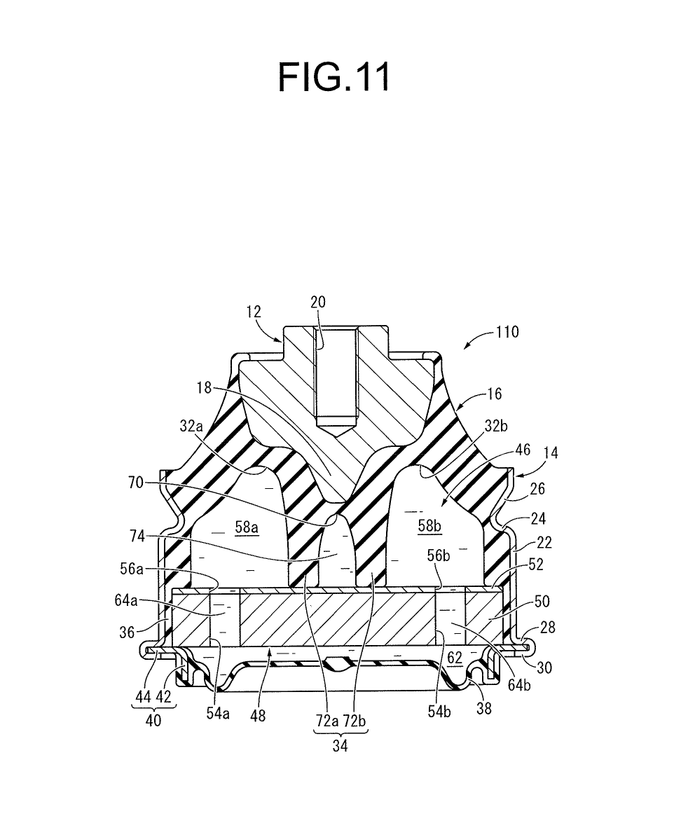

Referring next to FIG. 11, there is depicted an automotive engine mount 110 according to a fifth embodiment of a fluid-filled type vibration damping device constructed in accordance with the present invention. The engine mount 110 has a structure in which the support member 66 has been omitted from the engine mount 10 shown in the first embodiment, so that the lower end portion of the elastic separating wall 34 is permitted to displace relative to the partition member 48.

With the engine mount 110 of this construction mounted onto a vehicle, when large jarring load is input due to the vehicle riding over a bump or the like and an excessive negative pressure is exerted on the pressure-receiving chambers 58a, 58b (namely, fluid pressure of the pressure-receiving chambers 58a, 58b markedly drops), the first mounting member 12 undergoes large displacement upward with respect to the second mounting member 14. In association therewith, the elastic separating wall 34 bonded to the first mounting member 12 undergoes displacement upward so that the opening end face of the elastic separating wall 34 becomes spaced away from the partition member 48. Accordingly, a short-circuit passage for connecting the pressure-receiving chambers 58a, 58b and the dividing fluid chamber 74 is formed between axially opposed faces of the divided walls 72a, 72b and the partition member 48. In this way, the engine mount 110 according to the present embodiment is provided with a relief mechanism for short-circuiting pressure-receiving chambers 58a, 58b and the dividing fluid chamber 74 when an excessive negative pressure acts on the pressure-receiving chambers 58a, 58b due to input of large load. By so doing, the capacity of the pressure-receiving chambers 58a, 58b will be substantially increased, thereby ameliorating the negative pressure within the pressure-receiving chambers 58a, 58b. This will prevent cavitation caused by the negative pressure within the pressure-receiving chambers 58a, 58b, so that occurrence of noise can be avoided.

It should be appreciated that it would also be possible to desirably employ a combination of each structure illustrated in the second through fifth embodiments (namely, the second orifice passage 86 illustrated in the second embodiment, the third orifice passage 98 illustrated in the third embodiment, the fourth orifice passages 104a, 104b illustrated in the fourth embodiment, and the structure illustrated in the fifth embodiment in which the support member 66 has been omitted).

While the present invention has been described in detail hereinabove in terms of the preferred embodiments, the invention is not limited by the specific disclosures thereof. For example, whereas the preceding embodiments describe structures in which a pair of (two) pressure-receiving chamber 58a and the pressure-receiving chamber 58b are provided, three or more pressure-receiving chambers may be provided. As a specific example, it would also be acceptable to provide four pressure-receiving chambers, with two of them situated in opposition to each other in one diametrical direction, while the other two situated in opposition to each other in another diametrical direction. By so doing, effective vibration damping action will be exhibited in two diametrical directions mutually different from each other. Note that in the case where three or more pressure-receiving chambers are formed in this way, each elastic separating wall that separates the adjacent pressure-receiving chambers has a dividing recess which branches the each elastic separating wall into a pair of divided walls with the dividing recess being interposed therebetween, and provides a plurality of dividing fluid chambers.

Besides, whereas in the preceding embodiments, the first orifice passages 64a, 64b have a hole shape that perforates the partition member 48 in the axial direction, no particular limitation is imposed on the specific structure of the first orifice passage as long as it permits communication among the pressure-receiving chambers 58a, 58b and the equilibrium chamber 62. As a specific example, it would also be acceptable to provide a recessed groove that opens onto the upper face of the partition member body 50, and by covering the opening of the recessed groove with the lid member 52, formed is a tunnel-like passage. One end of the tunnel-like passage communicates with one of the pressure-receiving chambers 58a(58b), while the other end of the tunnel-like passage communicates with the equilibrium chamber 62, thereby providing a first orifice passage. Note that it will suffice for the recessed groove of this structure to be formed in an appropriate shape depending on the required tuning frequency for the first orifice passage or the like. However, in order to efficiently obtain the passage length thereof and afford a high degree of freedom in tuning, preferably employed are, for example, the ones extending in the circumferential direction, extending in a serpentine configuration in the diametrical direction, extending in a spiral shape, or the like.

In addition, no particular limitation is imposed on the specific structure of the second through fourth orifice passages 86, 98, 104a and 104b, as long as they are formed for interconnecting the desired fluid chambers.

Moreover, the range of application of the present invention is not restricted to engine mounts, but it can be applied to sub-frame mounts, body mounts, differential mounts and so forth. Furthermore, the fluid-filled type vibration damping device related to the present invention is not limited to implementation in automobiles, and may also preferably be implemented in motorized two wheeled vehicles, industrial vehicles, rail vehicles, or the like.

What is claimed is:

1. A fluid-filled type vibration damping device comprising:
a first mounting member;
a second mounting member having a tubular portion so that the first mounting member is positioned at one axial opening side of the tubular portion of the second mounting member;
a main rubber elastic body elastically connecting the first mounting member and the second mounting member;
a partition member supported by the second mounting member;
a plurality of pressure-receiving chambers whose walls are partially defined by the main rubber elastic body and that are formed on one side of the partition member;
an equilibrium chamber whose wall is partially defined by a flexible film and that is formed on another side of the partition member, the pressure-receiving chambers and the equilibrium chamber being filled with a non-compressible fluid;
a first orifice passage interconnecting the pressure-receiving fluid chambers and the equilibrium fluid chamber;
a plurality of pocket portions that are formed in the main rubber elastic body and open onto an axial end face of the main rubber elastic body facing the partition member so as to form the pressure-receiving chambers by means of openings of the pocket portions being covered with the partition member;
an elastic separating wall that is composed by the main rubber elastic body and separates the pressure-receiving chambers from one another;
a dividing recess that is formed in the elastic separating wall and opens onto an axial end face of the elastic separating wall facing the partition member; and
a dividing fluid chamber that is formed by means of an opening of the dividing recess being covered with the partition member and is filled with the non-compressible fluid.

2. The fluid-filled type vibration damping device according to claim 1, further comprising a support member provided to the second mounting member so as to span the tubular portion while extending in an axis-perpendicular direction, wherein the support member is bonded to an opening end portion of the elastic separating wall.

3. The fluid-filled type vibration damping device according to claim 1, further comprising a relief mechanism that is provided by means of, when an excessive negative pressure acts on the pressure-receiving chambers, an opening end face of the elastic separating wall being spaced away from the partition member and short-circuiting the pressure-receiving chambers and the dividing fluid chamber.

4. The fluid-filled type vibration damping device according to claim 1, wherein the pressure-receiving chambers comprise a pair of the pressure-receiving chambers that are situated in opposition to each other in an axis-perpendicular direction.

5. The fluid-filled type vibration damping device according to claim 4, wherein the tubular portion of the second mounting member has an oval tube shape, and the pair of the pressure-receiving chambers are situated in opposition to each other in a major axis direction of the tubular portion.

6. The fluid-filled type vibration damping device according to claim 1, wherein the first mounting member overlaps the pressure-receiving chambers when viewed in axial direction projection.

7. The fluid-filled type vibration damping device according to claim 1, wherein the first mounting member overlaps the pressure-receiving chambers when viewed in axis-perpendicular direction projection.

8. The fluid-filled type vibration damping device according to claim 1, further comprising a second orifice passage interconnecting the equilibrium chamber and the dividing fluid chamber.

9. The fluid-filled type vibration damping device according to claim 1, further comprising a third orifice passage interconnecting the pressure-receiving chambers.

10. The fluid-filled type vibration damping device according to claim 1, further comprising a fourth orifice passage interconnecting the pressure-receiving chambers and the dividing fluid chamber.
